(19) United States
(12) Patent Application Publication
(10) Pub. No.: US 2025/0384241 A1
(43) Pub. Date: Dec. 18, 2025

(54) SYSTEMS AND METHODS FOR NEURAL NETWORK BASED LANGUAGE MODELS OF FORECAST EXPLANATION

(71) Applicant: Salesforce, Inc., San Francisco, CA (US)

(72) Inventors: Ibrahim Taha Aksu, Singapore (SG); Chenghao Liu, Singapore (SG); Amrita Saha, Singapore (SG); Sarah Tan, Seattle, WA (US); Caiming Xiong, Menlo Park, CA (US); Doyen Sahoo, Singapore (SG)

(21) Appl. No.: 18/987,697

(22) Filed: Dec. 19, 2024

Related U.S. Application Data
(60) Provisional application No. 63/660,491, filed on Jun. 15, 2024.

(51) Int. Cl. G06N 3/045

(52) U.S. Cl. CPC G06N 3/045

(57) ABSTRACT

Embodiments described herein provide a method for time series forecast. The method includes: obtaining a set of time series data comprising a first segment of past time series data and a second segment of predicted time series data; generating, by a first neural network based language model, a text description describing a forecast explanation based on a first input prompt combining the set of time series data; generating, by a second neural network based language model, a third segment of predicted time series data based on a second input prompt combining the first segment of past time series data and the text description of forecast explanation; determining a performance metric based on a comparison between the second segment of predicted time series data and the third segment of predicted time series data; and generating a control command based on the text description to cause an action with a control system.

### CROSS REFERENCE(S)

The instant application is a nonprovisional of and claim priority under 35 U.S.C. 119 to U.S. provisional application No. 63/660,491, filed Jun. 15, 2024, which is hereby expressly incorporated by reference herein in its entirety.

### TECHNICAL FIELD

The embodiments relate generally to machine learning systems for time series forecast interpretation, and more specifically to systems and methods for evaluating forecast explainer neural network based language models.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. Forecast explainer large language model (LLM) can be used for interpreting time series forecast. However, evaluating such forecast explainer LLMs remains challenging due to scarcity of performance metrics that take into consideration of the complex causal relationships in time series data.

### BRIEF DESCRIPTION OF THE DRAWINGS

FIG. 1 shows an application of an explainer neural network based language model based on a time series forecast.

FIG. 2A is a simplified diagram illustrating an explainer evaluation framework, according to some embodiments.

FIG. 2B is a simplified diagram illustrating another explainer evaluation framework, according to some embodiments.

FIG. 2C shows certain elements in the explainer evaluation framework in FIG. 2A, according to some embodiments.

FIG. 2D shows certain elements in the explainer evaluation framework in FIG. 2B, according to some embodiments.

FIG. 3A is a simplified diagram illustrating a computing device implementing the explainer evaluation frameworks described in FIGS. 2A-2D, according to some embodiments.

FIG. 3B is a simplified diagram illustrating a neural network structure, according to some embodiments.

FIG. 4 is a simplified block diagram of a networked system suitable for implementing the explainer evaluation framework described in FIGS. 2A-2D and other embodiments described herein.

FIG. 5A shows a piece of pseudo code for evaluating direct simulatability of a forecast explanation performed by the explainer evaluation framework illustrated in FIGS. 2A and 2C, according to some embodiments.

FIG. 5B shows a piece of pseudo code for evaluating synthetic simulatability of a forecast explanation performed by the explainer evaluation framework illustrated in FIGS. 2B and 2D, according to some embodiments.

FIG. 6A is an example logic flow diagram illustrating a method of explainer evaluation based on the framework shown in FIGS. 2A, 2C, 3A, 3B, 4, and 5A according to some embodiments.

FIG. 6B is an example logic flow diagram illustrating a method of explainer evaluation based on the framework shown in FIGS. 2B, 2D, 3A, 3B, 4, and 5B according to some embodiments.

FIGS. 7A-7E provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

### Overview

Time-series forecasting has been widely used in finance and economics, technology and telecommunications, marketing, energy sector, healthcare, etc. Predicted time series data and past time series data may be input to an LLM to generate a natural language output explaining a reason why the time-series data is forecasted in the specific way. Such forecast explainer LLMs for interpreting time series forecast provide assistance to laypeople compared to explanations that require expert knowledge. However, it is often unclear and challenging to evaluate whether the generated explanation is accurate, based on which to improve the performance of the explainer LLM.

In view of the need for improving forecast explainer LLMs, embodiments described herein provide systems and methods for evaluating the simulatability of forecast explanations generated by a forecast explainer LLM. A forecast explainer LLM is evaluated by a server for its direct simulatability or synthetic simulatability. In both approaches, the forecast explanation generated by a forecast explainer LLM is used as the basis for generating simulation data. A higher simulatability indicates better forecast explanation. First, a forecast LLM is used to generate a set of forecast data based on a set of time series data. To evaluate the direct simulatability of the forecast explainer LLM, the set of time series data and the set of forecast data are provided to the forecast explainer LLM to generate a forecast explanation of the forecast data. The set of time series data and the forecast explanation are then provided to a predictor LLM to generate a set of predicted forecast data. The set of predicted forecast data and the set of forecast data are compared to determine the direct simulatability of the forecast explainer LLM. To evaluate the synthetic simulatability of a forecast explainer LLM, the forecast explanation is provided to another LLM to generate a set of new time series data. The set of new time series data is provided to the forecast explainer LLM to generate a set of new forecast data, while the set of new time series data and the forecast explanation are provided to the predictor LLM to generate a set of new predicted forecast data. The set of new predicted forecast data and the set of new forecast data are compared to determine the synthetic simulatability of the forecast explainer LLM. In both scenarios, if the forecast data is desirably accurate after the comparison, the corresponding forecast explanation can be used to generate control signals for controlling certain software and/hardware of a system, such as an autonomous driving system. Details may be described below.

Embodiments described herein provide a number of benefits. For example, the simulatability of a forecast explainer LLM can be evaluated using a direct simulatability or a synthetic simulatability. Based on the evaluation result, users can choose a suitable forecast LLM to generate time series forecast explanation for various applications that involve time series forecast, such as decision making using past time series data. Therefore, with improved performance on evaluation of forecast explainer LLMs, neural network technology in time series forecasting, such as AI-assisted chatbots for time series forecasting is improved.

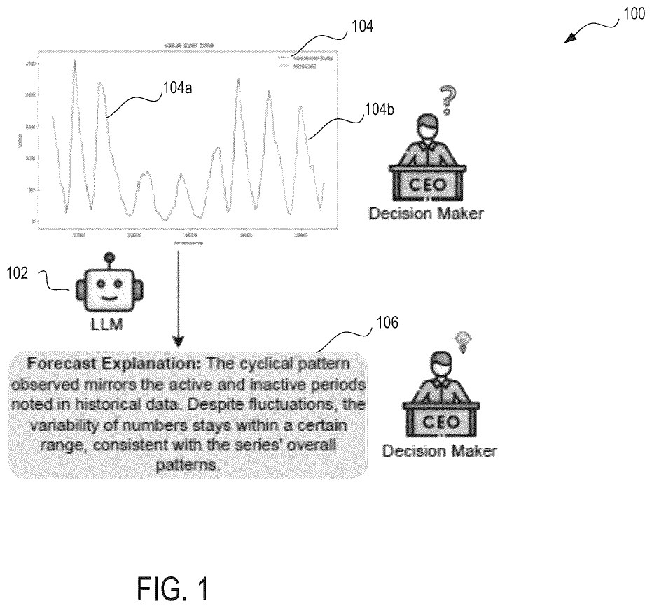

FIG. 1 shows a natural language explanation (NLE) application for a time series forecast by a forecast explainer LLM 102, according to some embodiments. Forecast explainer LLM 102 may include a suitable neural network model that receives natural language as input and outputs explanation in natural language. In various embodiments, forecast explainer LLM 102 include ChatGPT, GPT-4, and/or GPT-3.5, etc. Plot 104 may be based on a time series dataset, which includes a set of original time series data and a set of forecast data. The set of original time series data may correspond to curve 104a, and the set of forecast data may correspond to curve 104b. The set of forecast data may be generated/predicted by a forecaster (not shown) based on the set of original time series data. Forecast explainer LLM 102 may receive the time series dataset as the input and generate a forecast explanation 106 in natural language. In some embodiments, the time series dataset is inputted in the form of natural language, with the time series numbers separated by a special symbol, e.g., #. Forecast explanation 106 may describe the causal relationship between the set of original time series data and the set of forecast data. While plot 104 may be challenging for a layperson (e.g., “Decision Maker”) to interpret, forecast explanation 106 can interpret the causal relationship in natural language, which is easier for a layperson to understand.

In another example, time series plot 104 may represent forecast of biometrics data over a future period of time. For example, a biometric monitor, such as a wearable device, can collect time series data of human biometrics like heart rate, skin temperature, or blood oxygen levels. The device records these metrics continuously or at specific intervals, creating a detailed timeline of physiological changes. This data is transmitted, often via Bluetooth or Wi-Fi, to a connected smartphone or computer and subsequently uploaded to a cloud-based storage system. A server implementing a time-series forecast neural network model may predict future biometric trends. The explainer LLM 102 may in turn generate an explanation 106 associated with the forecast. Such reasoning insights 106 may be transmitted to a medical professional to assist with early detection of health anomalies, fitness optimization, or personalized healthcare interventions.

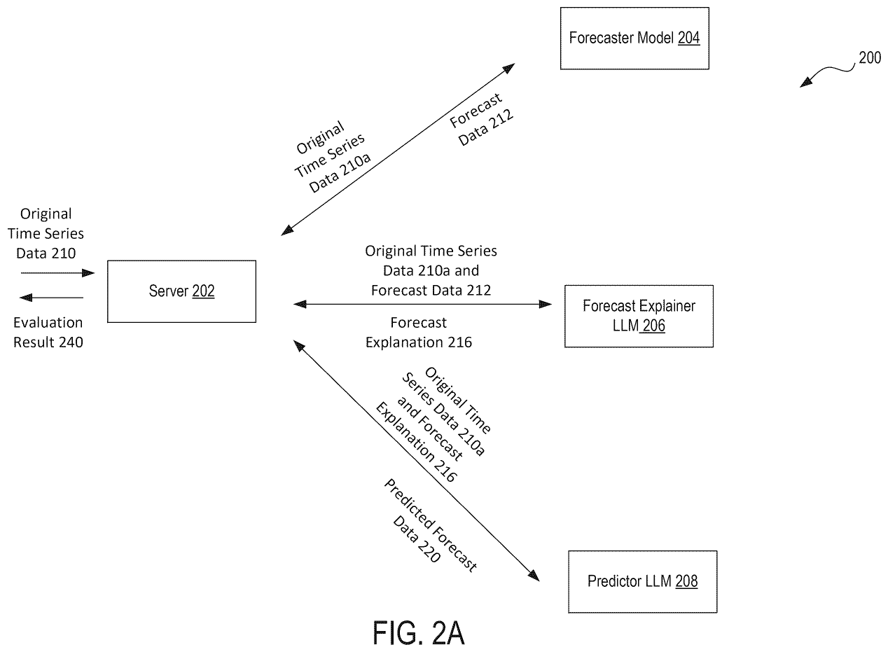

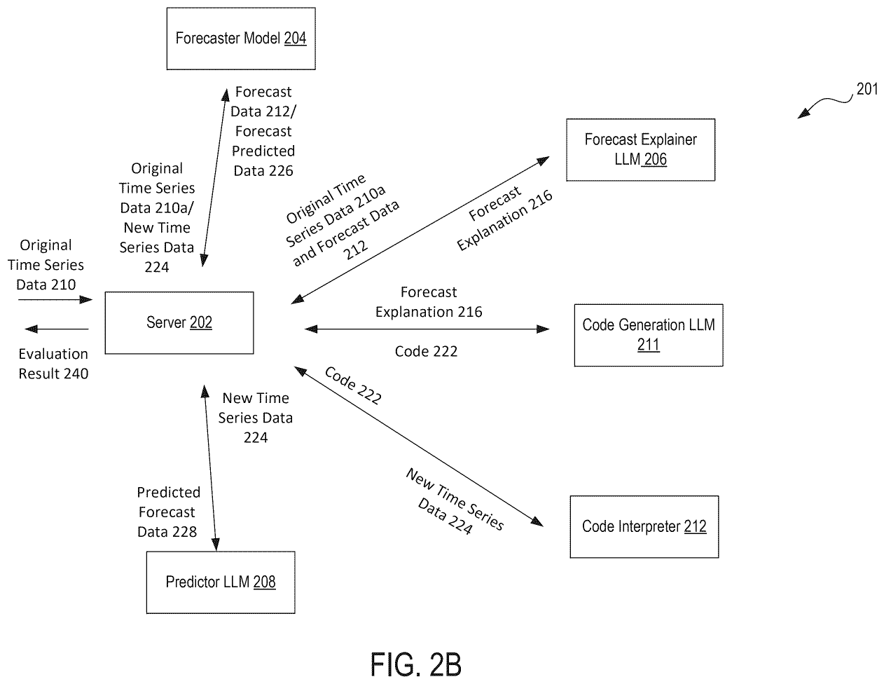

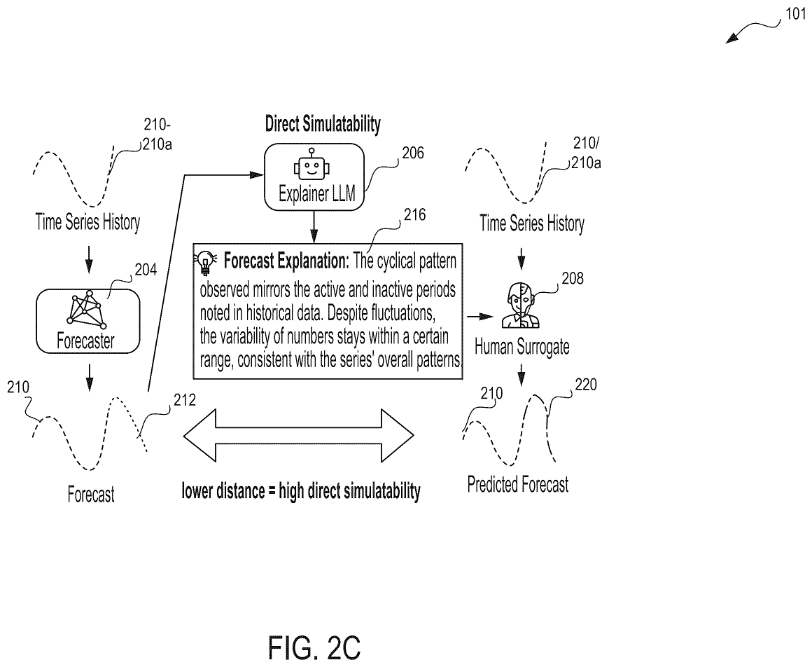

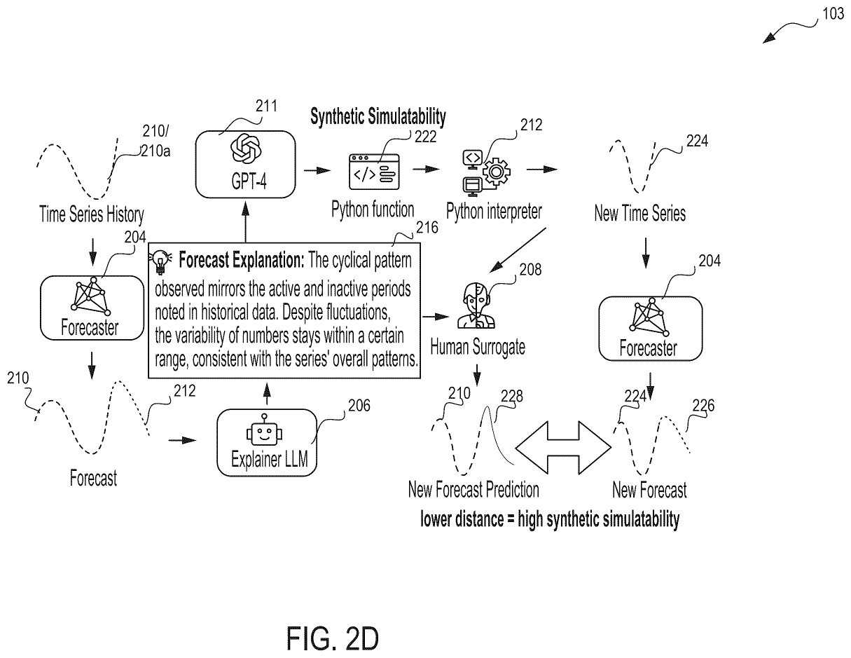

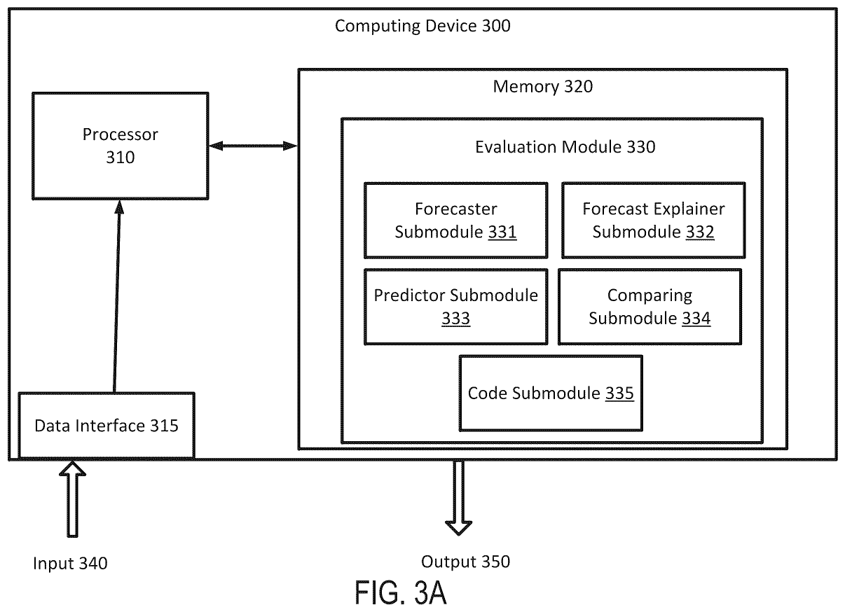

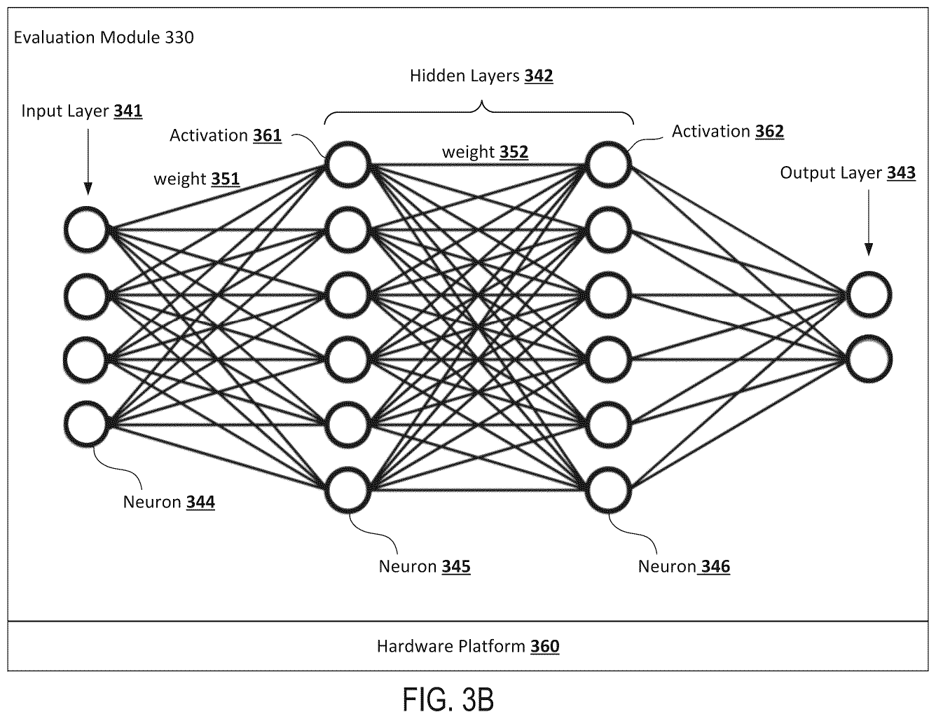

FIGS. 2A and 2B each shows an evaluation framework for evaluating one or more forecast explainer LLMs, according to embodiments of the present disclosure. FIGS. 2C and 2D respectively shows certain elements in the evaluation process by the two evaluation frameworks. For both evaluation frameworks, a forecast LLM may receive a set of original time series data (H) and generate a set of forecast data (F) based on the set of original time series data. A forecast explainer may generate a natural language explanation (NLE) based on the set of original time series data and the set of forecast data. Server 202 may evaluate the NLE to determine the performance of the forecast explainer. In this disclosure, given the triplet {H, F, NLE}, the goal is to evaluate the usefulness of NLE using a direct simulatability or a synthetic simulatability (described in FIGS. 2B, 2D, and 3B).

FIG. 2A is a simplified diagram illustrating an evaluation framework 200 according to some embodiments. The framework 200 comprises a server 202, which is operatively connected to a forecaster model 204, a forecast explainer LLM 206, and a predictor LLM 208 through respective application program interfaces (APIs). In some embodiments, server 202 includes a bot server that includes/builds a chatbot for interacting with humans. Specifically, server 202 (or the chatbot) may receive an input that includes a set of original time series data 210 from a user, and an output of evaluation result 240 with the performance of one or more forecast explainer LLMs.

Server 202 may receive set of original time series data 210 from a user. In some embodiments, set of original time series data 210 is also referred to as time series history, and can include a sequence of numerical values sampled at regular time intervals, denoted as

$${X}^{( i )} = \{ {x}_{1}^{( i )} , {x}_{2}^{( i )} , … , {x}_{T}^{( i )} \} , \qquad ( 1 )$$

where i∈ [symbol] represents the number of variates, T∈ [symbol] is the number of timestamps, and

$${x}_{t}^{( i )}$$

∈ [symbol] is the value of iₜₕ variate at timestamp t. In this disclosure, set of original time series data 210 may include univariate time series, meaning i=1. The objective of forecasting is to model the conditional distribution P(x_{t:T}|x_{1:t-1}).

As shown in FIGS. 2A and 2C, server 202 may transmit an input prompt combining a set of original time series data 210a and an instruction to forecaster model (“forecaster”) 204 via a respective API. The instruction may cause forecaster model 204 to generate a set of forecast data 212 based on set of original time series data 210a. Forecaster model 204 may be implemented by a suitable LLM, and is configured to generate a set of forecast data 212 given the input prompt. In some embodiments, forecaster model 204 includes any suitable models/algorithms that may generate forecast data 212. For example, forecaster model 204 may include one or more of a statistical model, a deep learning model, a transformer-based machine learning model, etc. In some embodiments, forecaster model 204 includes one or more LLMs such as GPT-4, GPT-3.5, etc. In some embodiments, set of original time series data 210a is generated by server 202 based on set of original time series data 210 to include natural language tokens corresponding to the numerical values and special tokens to separate the numerical values. For a given univariate time series data of length t, denoted as H={h₁, h₂, . . . hₜ}, forecaster model 204 may generate set of forecast data 212 for the next k time stamps F={f₁, f₂, . . . fₖ}, and may transmit set of forecast data 212 to server 202.

Upon receiving set of forecast data 212, server 202 may transmit an input prompt combining set of original time series data 210a and set of forecast data 212 and an instruction to forecast explainer LLM 206 via a respective API. The instruction may cause forecast explainer LLM 206 to generate a forecast explanation 216 in natural language (e.g., a natural language explanation, a text description of the explanation, or NLE) based on set of original time series data 210a and set of forecast data 212. In some embodiments, forecast explainer LLM 206 is implemented by a suitable LLM such as GPT-4, GPT-3.5, etc. Forecast explanation 216 may explain the causal relationship from H to F. Forecast explainer LLM 206 may transmit forecast explanation 216 to server 202.

Upon receiving forecast explanation 216, server 202 may transmit an input prompt that combines set of original time series data 210a, forecast explanation 216, and an instruction to predictor LLM 208 via a respective API. The instruction may cause predictor LLM 208 to generate a set of predicted forecast data 220 based on set of original time series data 210a and forecast explanation 216. Predictor LLM 208 may generate set of predicted forecast data 220 corresponding to the next k time stamps, and transmit set of predicted forecast data 220 to server 202. In some embodiments, predictor LLM 208 is also referred to as a “human surrogate” and can include a suitable LLM such as GPT-4, GPT-3.5, etc.

Upon receiving predicted forecast data 220, server 202 may determine a distance between set of forecast data 212 and predicted forecast data 220. A smaller distance may indicate higher usefulness of NLE (e.g., forecast explanation 216) or higher simulatability of forecast explainer LLM 206. In some embodiments, the distance includes symmetric mean absolute percentage error (rMAPE) and/or normalized root mean square error (NRMSE).

In some embodiments, server 202 may perform the evaluation on more than one forecast explainer LLM 206, and may output an evaluation result 240 that includes the distance for a respective forecast LLM 206. In some embodiments, server 202 may rank the distances corresponding to more than one forecast LLMs 206, and output an evaluation result 240 that shows the ranking and/or the explainer LLM with the lowest distance.

FIG. 2B is a simplified diagram illustrating an evaluation framework 201 according to some embodiments. The framework 201 comprises a server 202, which is operatively connected to a forecaster model 204, a forecast explainer LLM 206, a predictor LLM 208, a code generation LLM 210, and a code interpreter 212 through respective application program interfaces (APIs). Similar to framework 200, in some embodiments, server 202 includes a bot server that includes/builds a chatbot for interacting with humans. Server 202 may have an input that includes a set of original time series data 210, and an output that includes an evaluation result 240.

Similar to that of framework 200, server 202 may receive set of original time series data 210a from a user, and may transmit an input prompt combining set of original time series data 210a and an instruction to forecaster model 204 via a respective API. Caused by the instruction, forecaster model 204 may generate set of forecast data 212, and transmit set of forecast data 212 to server 202. Upon receiving set of forecast data 212, server 202 may transmit an input prompt combining set of original time series data 210a, set of forecast data 212, and an instruction to forecast explainer LLM 206. The instruction may cause forecast explainer LLM 206 to generate a forecast explanation 216. Forecast explainer LLM 206 may then transmit forecast explanation 216 to server 202.

Different from framework 200, as shown in FIGS. 2B and 2D, upon receiving forecast explanation 216, server may transmit an input prompt combining forecast explanation 216 and an instruction to code generation LLM 211, which includes a suitable LLM such as GPT-4. The instruction may cause code generation LLM 211 to generate code 222, e.g., programming code such as Python code, that includes functions for generating a set of new time series, based on forecast explanation 216, using natural language to code generation. In some embodiments, code generation LLM 211 generates the Python code based on a set of random seed numbers. Code generation LLM 210 may transmit code 222 to server 202.

Upon receiving code 222, server 202 may transmit code 222 to a code interpreter 212. In some embodiments, code interpreter 212 may include a simulator and may generate a set of new time series data 224 based on code 222. In some embodiments, code interpreter 212 may include a LLM, such as GPT-4, to generate set of new time series data 224 based on an input prompt that combines code 222 and an instruction to cause the LLM to generate set of new time series data 224 corresponding to the first t time stamps. Code interpreter 212 may transmit set of new time series data 224 to server 202.

Upon receiving set of new time series data 224, server 202 may transmit a first input prompt combining set of new time series data 224 and a first instruction to predictor LLM 208 via a respective API. The first instruction may cause predictor LLM 208 to generate a set of predicted forecast data 228 corresponding to the next k time stamps. Server 202 may also transmit a second input prompt combining set of new time series data 224 and a second instruction to predictor LLM 208 via the respective API. The second instruction may cause forecaster model 204 (“forecaster”) to generate a set of forecast predicted data 226 corresponding to the next k time stamps. Forecaster model 204 and predictor LLM 208 may respective transmit set of forecast predicted data 226 and set of predicted forecast data 228 to server 202.

Upon receiving set of predicted forecast data 228 and set of forecast predicted data 226, server 202 may determine a distance between set of predicted forecast data 228 and set of forecast predicted data 226. A smaller distance may indicate higher usefulness of NLE (e.g., forecast explanation 216) or higher simulatability of forecast explainer LLM 206. In some embodiments, the distance includes symmetric mean absolute percentage error (rMAPE) and/or normalized root mean square error (NRMSE). Similar to that of frame 200, in some embodiments, server 202 may perform the evaluation on more than one forecast explainer LLM 206, and may output an evaluation result 240 that includes the distance for a respective forecast LLM 206. In some embodiments, server 202 may rank the distances corresponding to more than one forecast LLMs 206, and output an evaluation result 240 that shows the ranking and/or the explainer LLM with the lowest distance.

In some embodiments, framework 200 and/or framework 201 may be part of or communicatively coupled to another control system. In some embodiments, when the distance (e.g., determined using rMAPE and/or NRMSE) is determined to be lower than a predetermined threshold value, forecast explanation 216 can be used to generate control signals for controlling certain software and/or hardware of the control system. In some embodiments, framework 200 and/or framework 201 may be part of or be communicatively coupled to an autonomous driving system. In an example, set of original time series data 210 includes positioning data (e.g., satellite signals, light detection and ranging (LiDAR) signals, etc.), traffic data, road condition data, and so on, used to localize a vehicle and/or generate navigation commands. For example, when the distance is below a predetermined threshold value (indicating forecast explanation 216 is sufficiently accurate), forecast explanation 216 can be used to generate control commands used to localize and/or navigate the vehicle.

### Computer and Network Environment

FIG. 3A is a simplified diagram illustrating a computing device implementing the evaluation frameworks 200 and 201 described in FIGS. 2A-2D, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for evaluation module 330 that may be used to implement and/or emulate the systems and models, and/or to implement any of the methods described further herein. evaluation module 330 may receive input 340 such as an input training data (e.g., a set of original time series data) via the data interface 315 and generate an output 350 which may be an evaluation result.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as a set of original time series data, from a user via the user interface.

In some embodiments, the evaluation module 330 is configured to output an evaluation result in response to a set of original time series data. The evaluation module 330 may further include a forecaster submodule 331, a forecast explainer submodule 332, a predictor submodule 333, a comparing submodule 334, and optionally, a code submodule 335. In some embodiments, submodules 331-334 are configured to perform similar operations as server 202 in evaluation framework 200, and submodules 331-335 are configured to perform similar operations as server 202 in evaluation framework 201. Forecaster submodule 331 may be configured to generate a set of forecast data (e.g., by forecast LLM 204) in response to a set of original time series data. Forecast explainer submodule 332 may be configured to generate a NLE (e.g., by forecast explainer LLM 206) in response to the set of original time series data and the set of forecast data.

To perform the functions of evaluation framework 200, predictor submodule 333 may be configured to generate a set of predicted forecast data (e.g., by predictor LLM 208) in response to the set of original time series data and the forecast explanation. Comparing submodule 334 may determine the distance between the set of forecast data and the set of predicted forecast data.

To perform the functions of evaluation framework 201, code submodule 335 may be configured to generate a set of time times series data from a programming code piece (e.g., Python, by a code generation LLM and a code interpreter) in response to the forecast explanation. Predictor submodule 333 may be configured to generate a set of predicted forecast data 228, while forecaster submodule 331 may be configured to generate a set of forecast predicted data 226. Comparing submodule 335 may determine the distance between the set of predicted forecast data 228 and the set of forecast predicted data 226.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the evaluation module 330 described in FIG. 3A, according to some embodiments. In some embodiments, the evaluation module 330 and/or one or more of its submodules 331-335 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as a set of original time series data. The number of nodes (neurons) in the input layer 341 may be determined by the dimensionality of the input data (e.g., the length of a vector of a set of original time series data). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the evaluation module 330 receives an input 340 of a set of original time series data and transforms the input into an output 350 of an evaluation result. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the evaluation module 330 and/or one or more of its submodules 331-335 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be GPT-4, GPT-3.5, ChatGPT, and/or the like.

In one embodiment, the evaluation module 330 and its submodules 331-335 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the evaluation module 330 and its submodules 331-335 may be implemented by hardware, software and/or a combination thereof. For example, the evaluation module 330 and its submodules 331-335 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In another embodiment, some or all of layers 341, 342, 343 and/or neurons 342, 345, 346, and operations there between such as activations 361, 362, and/or the like, of the evaluation module 330 and its submodules 331-335 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the evaluation module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based evaluation module 330 and one or more of its submodules 331-335 may be trained by iteratively updating the underlying parameters (e.g., weights 351, 352, etc., bias parameters and/or coefficients in the activation functions 361, 362 associated with neurons) of the neural network based on a loss. For example, during forward propagation, the training data such as a set of original time series data are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding a set of correct predicted forecast data) from the training data, to compute a loss function that measures the discrepancy between the predicted output and the expected output. For example, the loss function may be cross entropy and/or MMSE. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based evaluation module 330 and one or more of its submodules 331-335 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

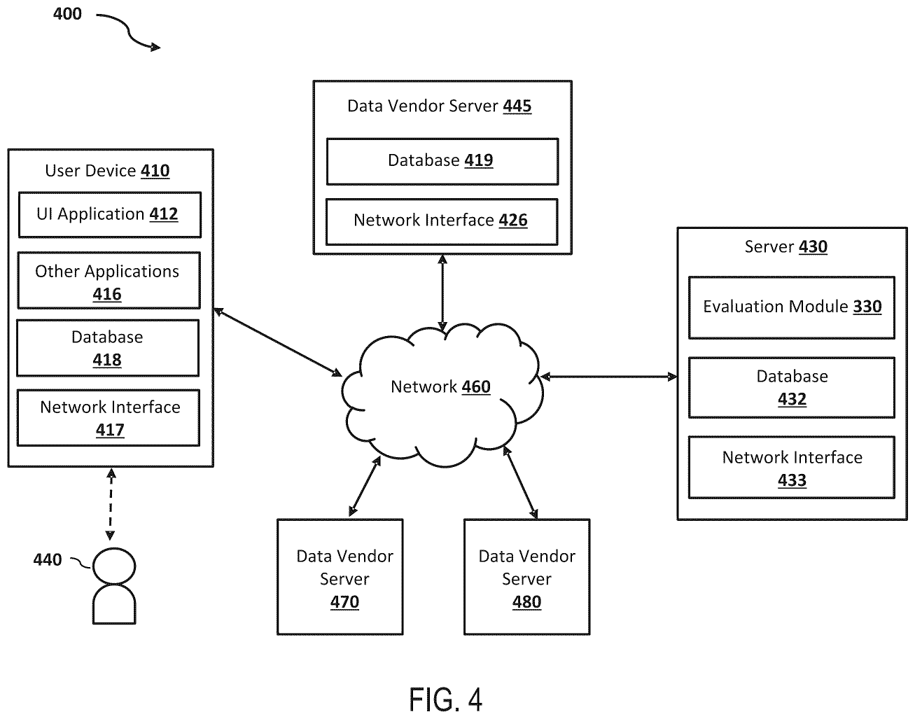

In one embodiment, evaluation module 330 and its submodules 331-335 may be housed at a centralized server (e.g., computing device 300) or one or more distributed servers. For example, one or more of evaluation module 330 and its submodules 331-335 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as providing an evaluation result in response to a set of original time series data.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in time series forecasting.

FIG. 4 is a simplified block diagram of a networked system 400 suitable for implementing the evaluation framework described in FIGS. 2A-2D and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a set of time series data from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the evaluation module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which evaluation module 330 may generate a response via the process described in FIGS. 2A-2D (e.g., evaluation result 240). The evaluation module 330 may thus cause a display of performance or ranking of one or more forecast explainer LLMs at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view an evaluation result, such as performance or ranking of one or more forecast explainer LLMs.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including pairs of (set of original time series data and forecast explanation, set of predicted forecast data) or pairs of (set of new time series data, set predicted forecast data) to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the evaluation module 330 and its submodules described in FIG. 3A. In some implementations, evaluation module 330 may receive data from database 419 at the data vendor server 445 via the network 460 to generate an evaluation result. The generated evaluation result may also be sent to the user device 410 for review by the user 440 via the network 460.

The database 432 may be stored in a transitory and/or non-transitory memory of the server 430. In one implementation, the database 432 may store data obtained from the data vendor server 445. In one implementation, the database 432 may store parameters of the evaluation module 330. In one implementation, the database 432 may store previously generated evaluation results, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

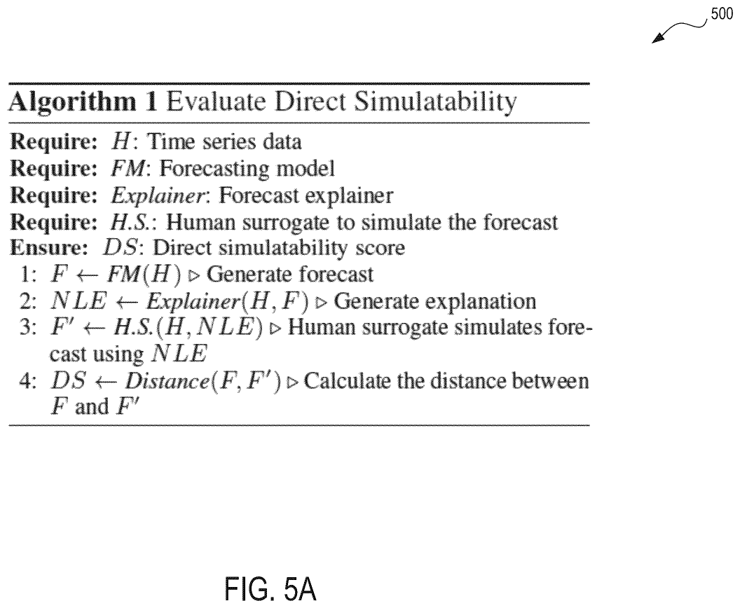

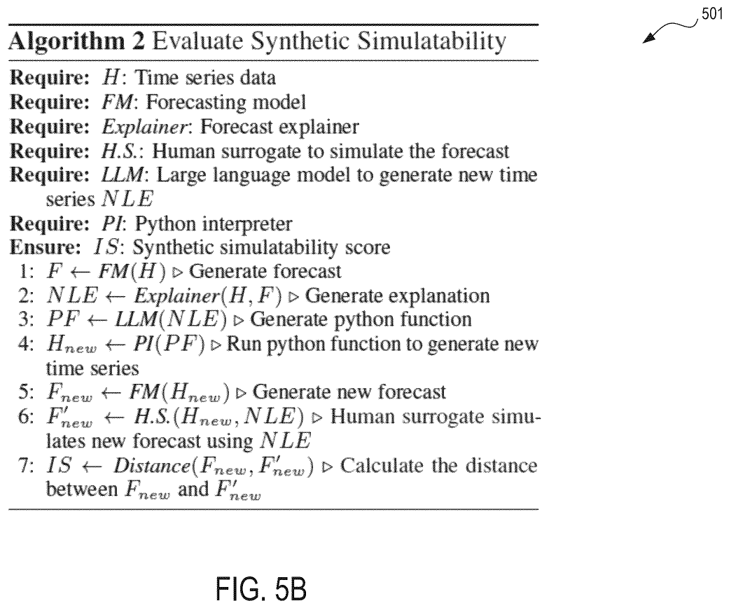

FIG. 5A provides an example pseudo-code segment illustrating an example algorithm 1 for a method 500 of evaluation based on the evaluation framework shown in FIGS. 2A and 2C to determine a direct simulatability (“DS”) of a forecast explainer LLM. FIG. 2B provides an example logic flow diagram illustrating method 500 of evaluation according to the algorithm 1 in FIG. 5A, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to an example operation of the evaluation module 330 (e.g., FIG. 3A).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a set of time series data (“H”), a forecaster model (“FM”), a forecast explainer LLM (“Explainer”), and a predictor LLM (“H.S” or human surrogate to simulate the forecast) may be obtained, as shown in lines 1-4 of algorithm 1.

At step 504, a set of forecast data (“F”) is generated by FM based on H, as shown in line 5 of algorithm 1.

At step 506, a natural language explanation (NLE) is generated by the “Explainer” based on Hand F, as shown in line 6 of algorithm 1.

At step 508, a set of predicted forecast data (“F′”) is generated by H.S. based on H and NLE, as shown in line 7 of algorithm 1.

At step 510, the DS is determined based on the distance between F and F′, as shown in line 8 of algorithm 1.

FIG. 5B provides an example pseudo-code segment illustrating an example algorithm 2 for a method 501 of evaluation based on the evaluation framework shown in FIGS. 2B and 2D to determine a synthetic simulatability (“IS”) of a forecast explainer LLM. FIG. 2D provides an example logic flow diagram illustrating method 501 of evaluation according to the algorithm 2 in FIG. 5B, according to some embodiments described herein. One or more of the processes of method 501 may be implemented, at least in part, in the form of executable code stored on non-transitory, tangible, machine-readable media that when run by one or more processors may cause the one or more processors to perform one or more of the processes. In some embodiments, method 501 corresponds to an example operation of the evaluation module 330 (e.g., FIG. 3A).

As illustrated, the method 501 includes a number of enumerated steps, but aspects of the method 501 may include additional steps before, after, and in between the enumerated steps. In some aspects, one or more of the enumerated steps may be omitted or performed in a different order.

At step 503, a set of time series data (“H”), a forecaster model (“FM”), a forecast explainer LLM (“Explainer”), a predictor LLM (“H.S” or human surrogate to simulate the forecast) may be obtained, a code generation LLM (“LLM” or large language model to generate new time series), and a Python interpreter (PI) may be obtained.

At step 505, a set of forecast data (“F”) is generated by FM based on H, as shown in line 9 of algorithm 2.

At step 507, a natural language explanation (“NLE”) is generated by the “Explainer” based on H and F, as shown in line 10 of algorithm 2.

At step 509, programming code (e.g., Python function of PF) may be generated by LLM based on NLE. NLE, as shown in line 11 of algorithm 2.

At step 511, a set of new time series data (“H_{new}”) is generated by PI based on PF, as shown in line 12 of algorithm 2.

At step 513, a set of forecast predicted data (“F_{new}”) is generated by FM based on H_{new}, as shown in line 13 of algorithm 2.

At step 515, a set of predicted forecast data (“F′_{new}”) is generated by H.S. based on H_{new} and NLE, as shown in line 14 of algorithm 2.

At step 517, the IS is determined based on the distance between F_{new} and F′_{new}, as shown in line 8 of algorithm 1, as shown in line 15 of algorithm 2.

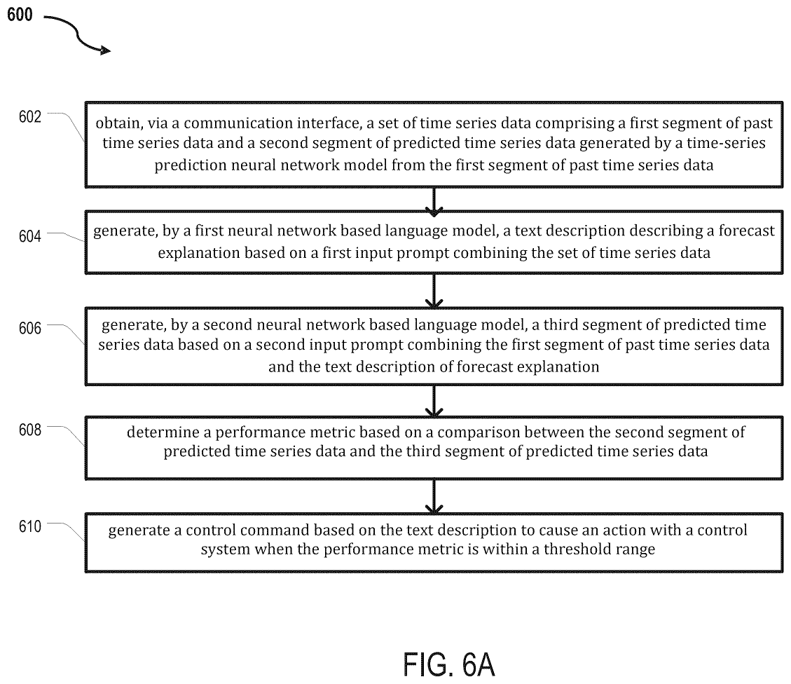

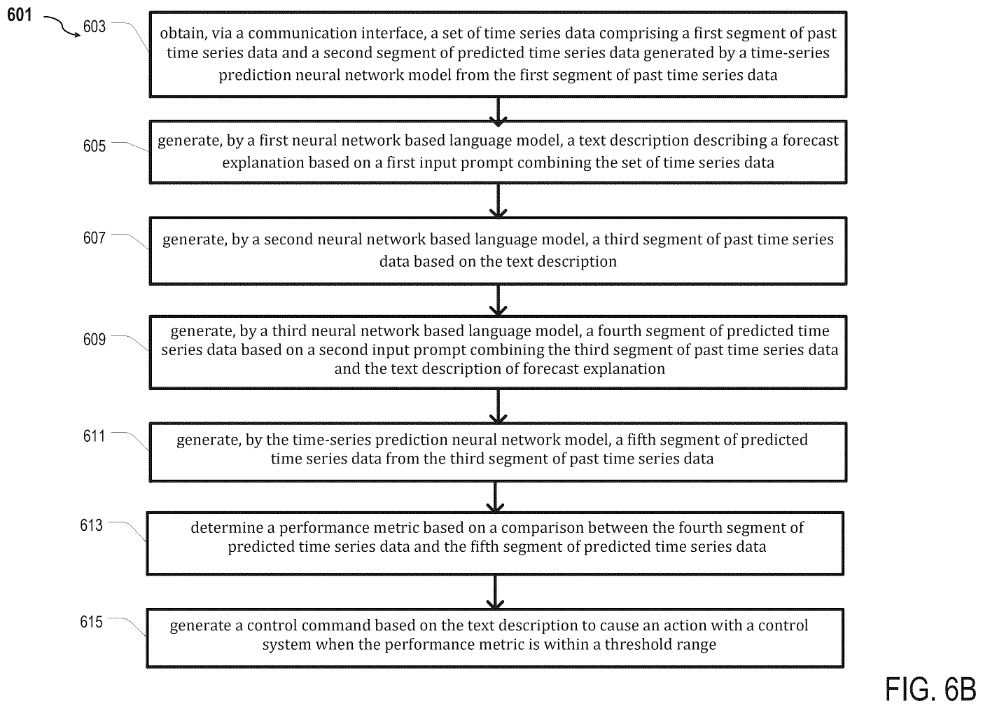

FIG. 6A is an example logic flow diagram illustrating a method of direct stimulability evaluation based on the framework shown in FIGS. 2A, 2C, 3A, 3B, 4, and 5A, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the evaluation module 330 (e.g., FIGS. 3A and 4) that performs Evaluating the performance of forecast explainer LLMs.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a set of time series data is obtained via a communication interface. The set of time series data include a first segment of past time series data and a second segment of predicted time series data generated by a time-series prediction neural network model from the first segment of past time series data. In some embodiments, the time-series prediction neural network model receives the first segment of past time series data in a form of natural language, and generates the second segment of predicted time series data in a form of natural language.

At step 604, a text description describing a forecast explanation is generated, by a first neural network based language model, based on a first input prompt combining the set of time series data. In some embodiments, the first neural network based language model generates the text description based on at least one of trend, seasonality, statistics, or cycle inconsistencies.

At step 606, a third segment of predicted time series data is generated, by a second neural network based language model, based on a second input prompt combining the first segment of past time series data and the text description of forecast explanation.

At step 608, a performance metric is determined based on a comparison between the second segment of predicted time series data and the third segment of predicted time series data. In some embodiments, the performance metric comprises a symmetric mean absolute percentage error (sMAPE).

At step 610, a control command is generated based on the text description to cause an action with a control system when the performance metric is within a threshold range. In some embodiments, the control system includes an autonomous driving system, and the first segment of past time series data comprises a set of positioning data, a set of traffic data, or a set of road condition data.

FIG. 6B is an example logic flow diagram illustrating a method of direct stimulability evaluation based on the framework shown in FIGS. 2B, 2D, 3A, 3B, 4, and 5B, according to some embodiments described herein. One or more of the processes of method 601 may be implemented, at least in part, in the form of executable code stored on non-transitory, tangible, machine-readable media that when run by one or more processors may cause the one or more processors to perform one or more of the processes. In some embodiments, method 601 corresponds to the operation of the evaluation module 330 (e.g., FIGS. 3A and 4) that performs Evaluating the performance of forecast explainer LLMs.

As illustrated, the method 601 includes a number of enumerated steps, but aspects of the method 601 may include additional steps before, after, and in between the enumerated steps. In some aspects, one or more of the enumerated steps may be omitted or performed in a different order.

At step 603, a set of time series data is obtained via a communication interface. The set of time series data includes a first segment of past time series data and a second segment of predicted time series data generated by a time-series prediction neural network model from the first segment of past time series data. In some embodiments, the time-series prediction neural network model receives the first segment of past time series data in a form of natural language, and generates the second segment of predicted time series data in a form of natural language.

At step 605, a text description describing a forecast explanation is generated, by a first neural network based language model, based on a first input prompt combining the set of time series data. In some embodiments, the first neural network based language model generates the text description based on at least one of trend, seasonality, statistics, or cycle inconsistencies.

At step 607, a third segment of past time series data is generated, by a second neural network based language model, based on the text description. In some embodiments, the generating, by the second neural network based language model, of the third segment of past time series data based on the text description includes: generating, by the second neural network based language model, a programming function based on the text description; and generating, by a programming interpreter, the third segment of past time series data from the programming function. In some embodiments, the programming function includes a Python function, and the programming interpreter includes a Python interpreter. In some embodiments, the second neural network based language model generates the third segment of past time series data based on a set of random seed numbers.

At step 609, a fourth segment of predicted time series data is generated by a third neural network based language model, based on a second input prompt combining the third segment of past time series data and the text description of forecast explanation.

At step 611, a fifth segment of predicted time series data is generated, by the time-series prediction neural network model, from the third segment of past time series data.

At step 613, a performance metric is determined based on a comparison between the fourth segment of predicted time series data and the fifth segment of predicted time series data. In some embodiments, the performance metric comprises a symmetric mean absolute percentage error (sMAPE).

At step 615, a control command is generated based on the text description to cause an action with a control system when the performance metric is within a threshold range. In some embodiments, the control system comprises an autonomous driving system, and the first segment of past time series data comprises a set of positioning data, a set of traffic data, or a set of road condition data.

In one embodiment, method 600 and/or is applicable in a variety of applications. For example, the task request received by a neural network model (e.g., original time series data 210) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method(s) 600 and/or 601, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method(s) 600 and/or 601 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

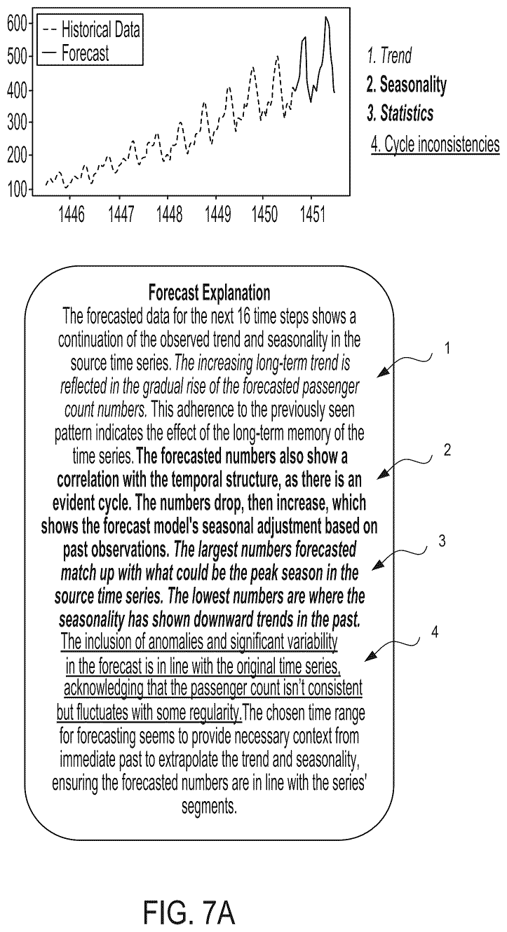

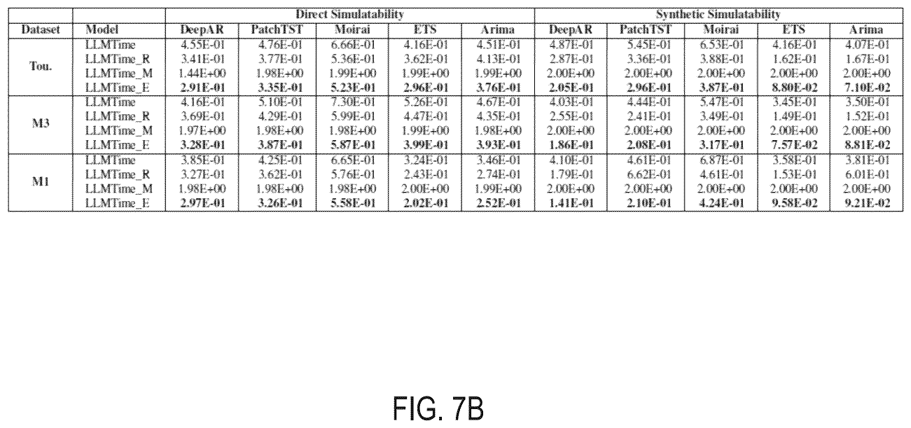

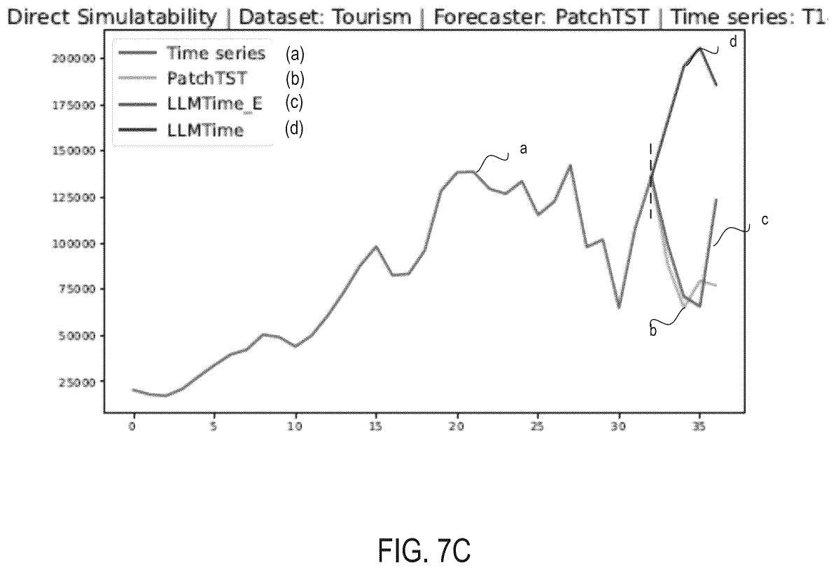

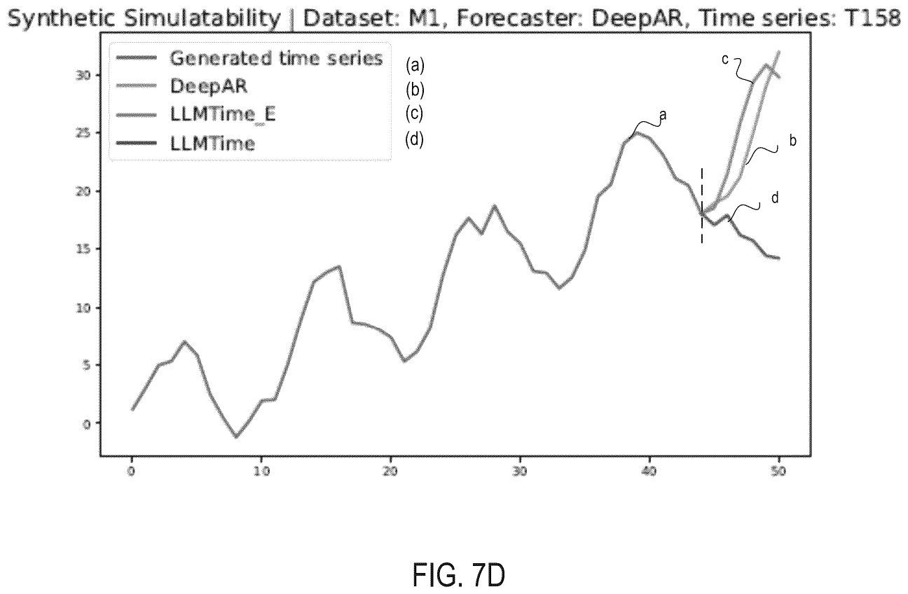

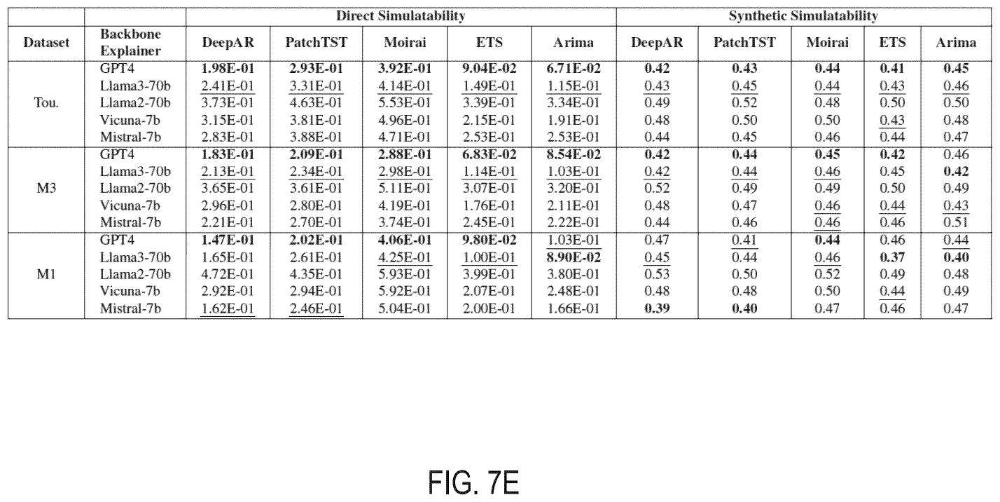

FIGS. 7A-7E represent exemplary test results using embodiments described herein.

A Baseline Explainer (e.g., explainer LLM) is designed. To thoroughly test the evaluation metrics, a baseline explainer is designed for generating NLEs for forecasts, as no existing baselines are available. This baseline explainer is based on early work by Warner (Rebecca M Warner. 1998c, Spectral analysis of timeseries data. Spectral analysis of time-series data. Guilford Press, New York, NY, US), which offers techniques for interpreting time series data without requiring specialized knowledge. According to Warner (Rebecca M Warner. 1998a. Chapter 1: [Research Questions], pages 4-7; Rebecca M Warner. 1998b. Chapter 7: [Summary of Univariate Time Series Data], pages 100-102) the key steps for explaining time series are: i) Statistics: Screen the data to assess distribution, outliers, and relevant characteristics. ii) Trend: Analyze linear trends to determine how much variance they account for. iii) Seasonality: Look for cyclic patterns in the data. iv) Cycle Inconsistencies: Describe changes in cycle irregularities, such as variations in peak amplitude over time. Following the steps listed above, characteristics using statistical methods are extracted. We then iteratively prompt a LLM to generate a summary of the time series, the forecast, and the relationship between the two.

Given the length of time series data, these steps are applied to smaller segments and prompt the LLM to explain each separately, then aggregate them into a final explanation. Following Sharma et al. (Mandar Sharma, John S. Brownstein, and Naren Ramakrishnan, 2021, T3: Domain-agnostic neural timeseries narration. 2021 IEEE International Conference on Data Mining (ICDM), pages 1324-1329), the time series are segmented based on slope changes. Then the following is performed: i) Perform quantitative analysis on each segment, calculating and formatting trend, seasonality, mean, and standard deviation into a templated summary; ii) Concatenate the segment analyses and prompt the LLM to generate a comprehensive analysis of the full time series; iii) Provide the LLM with the historical data, black-box forecast, and comprehensive analysis to generate a short report interpreting the forecast. FIG. 7A shows a sample explanation generated by this pipeline.

Experiment is setup as follows. Datasets are generated. Time series data are collected from three datasets in the Monash Repository (Rakshitha Godahewa, Christoph Bergmeir, Geoffrey I. Webb, Rob J. Hyndman, and Pablo Montero-Manso, 2021, Monash time series forecasting archive, In Neural Information Processing Systems Track on Datasets and Benchmarks): Tourism, M3, and M1. To ensure the effectiveness of our metrics, the backbone LLM may perform reasonably well in forecasting. The experiment focused on yearly frequencies due to shorter sequence lengths, as LLM forecasting performance declines with longer sequences (Elizabeth Fons, Rachneet Kaur, Soham Palande, Zhen Zeng, Svitlana Vyetrenko, and Tucker Hybinette Balch, 2024, Evaluating large language models on time series feature understanding: A comprehensive taxonomy and benchmark). As LLMs improve in time series reasoning, the metrics of the present disclosure (direct simulatability and synthetic simulatability) can be applied to any frequency.

Models are selected. To test if the disclosed evaluation metrics are forecasting method-agnostic, diverse LLM models are selected as forecasters/forecasting models, including statistical methods like auto ARIMA and auto ETS (Federico Garza, Max Mergenthaler Canseco, Cristian Challu, and Kin G. Olivares, 2022, StatsForecast: Lightning fast forecasting with statistical and econometric models, PyCon Salt Lake City, Utah, US 2022), deep learning models like DeepAR (Valentin Flunkert, David Salinas, and Jan Gasthaus, 2017, Deepar: Probabilistic forecasting with autoregressive recurrent networks), and transformer-based models like Moirai (Gerald Woo, Chenghao Liu, Akshat Kumar, Caiming Xiong, Silvio Savarese, and Doyen Sahoo, 2024, Unified training of universal time series forecasting transformers) and PatchTST (Yuqi Nie, Nam H. Nguyen, Phanwadee Sinthong, and Jayant Kalagnanam, 2022, A time series is worth 64 words: Long-term forecasting with transformers). These forecasters made predictions on the datasets, and explanations are generated using the baseline method mentioned above with various SoTA LLMs, both open and closed source. The resulting dataset of time series, forecast, and explanation triplets was used to evaluate our metrics and compare LLMs' explanation capabilities.

For both metrics, sanity checks with GPT-4 generated explanations were run first, using three baselines: LLMTime: a naive baseline that predicts the forecast without any explanation; LLMTime_R: which uses the baseline method described, but explains a random forecast; LLMTime_M: which prompts LLMTime to predict a constant value for all steps. These baselines are compared against LLMTime_E which uses the correct forecast as the baseline method.

Through sanity checks, it is expected LLMTime_E, using the correct explanation, to predict the forecast better than the other baselines. Afterward, we the experiments are extended to other LLMs to compare how explanations from different models improve forecast prediction. Hyperparameter settings for LLMs are detailed in Appendix F.1.

GPT-4 is used as the backbone for LLMTime in all experiments because preliminary experiments showed it consistently benefits from useful explanations. Llama-3 performed better without explanations but showed inferior results when explanations were provided, making it unsuitable for the study, which relies on the human surrogate (e.g., predictor LLM) benefiting from explanations to test performance metrics.

Evaluation Metrics are determined. Both performance metrics measure the distance of the prediction to the black-box model forecast and since the time series data used and generated have diverse scales, scale-independent metrics are used. Specifically, Symmetric Mean Absolute Percentage Error (sMAPE) is used for evaluation.

FIG. 7B presents the results of the sanity check experiments for both simulatability metrics, averaged over three runs. Notably, prepending textual data improves forecasting, regardless of whether the forecast is actual or random (cf. LLMTime vs. LLMTime_R and LLMTime_E). This likely stems from the engineered nature of the explanation pipeline, which is designed to aid forecasting.

As expected, LLMTime_M, with an adversarial prompt forcing arbitrary predictions, shows greater deviation from the original forecast, impairing results. In contrast, LLMTime_E, seeded with the correct forecast, consistently yields the closest predictions to the black-box model. This demonstrates that both simulatability metrics effectively distinguish between good and bad explanations.

Two qualitative examples are examined in FIGS. 7C and 7D, for direct simulatability and synthetic simulatability. Since these metrics quantify how helpful the explanations are in predicting a model's forecast, it is crucial to understand their meaningful impact on predictions. Diverse datasets and forecasters are used in these examples to demonstrate the evaluation metrics' capabilities across different setups.

FIG. 7C shows an example from the Tourism dataset using the PatchTST model. LLMTime forecast assumes the continuation of the recent rising trend. However, with the explanation, which suggests a declining trend with patterns of oscillations, LLMTime_E's prediction aligns better with the behavior of PatchTST.

For synthetic simulatability, the time series is generated at runtime based on the explanation. There are two aspects to analyze: (i) whether the generated time series accurately represents the explanation, and (ii) whether the explanation improves the prediction of the forecaster's output. It is observed that the generated time series in FIG. 7D contains cyclical patterns as mentioned in the explanation, and the ground truth forecast maintains these cycles as suggested. Also, LLMTime_E's generation, which utilizes the explanation, aligns more closely with the DeepAR forecast.

Overall, it is observed that high-quality explanations help the language model make better predictions of the black-box forecasting model's output.

Next, different backbone LLMs are compared using the baseline explainer. For synthetic simulatability, since time series are generated at runtime, comparing sMAPE across explainers is unfair due to sample variability. To ensure fairness, the results are normalized by LLMTime performance:

$$N S S ( L L M T i m {e}_{E} ) = \frac{SS ( {LLMTime}_{E} )}{S S ( L L M T i m e ) + SS ( {LLMTime}_{E} )} \qquad ( 1 )$$

where SS and NSS stands for synthetic and normalized synthetic simulatability respectively.

It is emphasized that direct and synthetic simulatability are not directly comparable, as they evaluate performance on different time series. While synthetic simulatability may seem harder due to loosely related time series, the generated task could still be simpler. The key comparison in this section focuses on which LLM improves the forecast the most in both direct and synthetic simulatability, evaluated separately.

FIG. 7E presents the results, GPT-4 produces the best explanations for predicting black-box model forecasts, with Llama3-70b performing best among open-source models. According to both metrics, GPT-4 explanations most effectively help predict black-box model forecasts in most cases. However, since LLMTime also uses GPT-4 as the backbone model, these results might be influenced by alignment. The performance difference between Llama2 and Llama3 aligns with findings that the latter excels in math reasoning benchmarks like GSM8K and MATH (Edward Beeching, Clementine Fourrier, Nathan Habib, Sheon Han, Nathan Lambert, Nazneen Rajani, Omar Sanseviero, Lewis Tunstall, and Thomas Wolf, 2023, Open llm leaderboard, https://huggingface. co/spaces/open-llm-leaderboard/open_llm_leaderboard.). Although not directly transferable, it is believed that high reasoning performance on numerical tasks indicates better reasoning on time series data.

The correlation between Model Size and Performance is studied. Judging by the Llama2-70B results, model size alone does not guarantee high-quality explanations. For example, Vicuna-7b outperforms Llama2-70B on most dataset-forecaster pairs across both metrics, despite having ten times fewer parameters. This suggests that numerical reasoning may correlate with better time series reasoning, as Vicuna-7b has demonstrated stronger numerical reasoning compared to larger models (Lianmin Zheng, Wei-Lin Chiang, Ying Sheng, Siyuan Zhuang, Zhanghao Wu, Yonghao Zhuang, Zi Lin, Zhuohan Li, Dacheng Li, Eric P. Xing, Haotong Zhang, Joseph Gonzalez, and Ion Stoica, 2023, Judging llm-as-a-judge with mt-bench and chatbot arena.).

Explanations across forecaster families are studied. A key question is whether explanations behave similarly across model families. The direct simulatability metric is used for comparison, as it uses the same time series to simulate each forecaster's predictions. As shown in FIG. 7E, PatchTST and Moirai have the largest error values for simulatability, likely due to patch embeddings and our use of short time series sequences. When the context is shorter than the minimum patch size, these models underperform, affecting explanation quality. In contrast, statistical models show the smallest error, likely because their simpler behavior is easier to explain in natural language.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is;:

1. A method for time series forecast, comprising:
obtaining, via a communication interface, a set of time series data comprising a first segment of past time series data and a second segment of predicted time series data generated by a time-series prediction neural network model from the first segment of past time series data;
generating, by a first neural network based language model, a text description describing a forecast explanation based on a first input prompt combining the set of time series data;
generating, by a second neural network based language model, a third segment of predicted time series data based on a second input prompt combining the first segment of past time series data and the text description of forecast explanation;
determining a performance metric based on a comparison between the second segment of predicted time series data and the third segment of predicted time series data; and
generating a control command based on the text description to cause an action with a control system when the performance metric is within a threshold range.

2. The method of claim 1, wherein the time-series prediction neural network model receives the first segment of past time series data in a form of natural language, and generates the second segment of predicted time series data in a form of natural language.

3. The method of claim 1, wherein the performance metric comprises a symmetric mean absolute percentage error (sMAPE).

4. The method of claim 1, wherein the first neural network based language model generates the text description based on at least one of trend, seasonality, statistics, or cycle inconsistencies.

5. The method of claim 1, wherein the control system comprises an autonomous driving system, and the first segment of past time series data comprises a set of positioning data, a set of traffic data, or a set of road condition data.

6. A method for time series forecast, comprising:
obtaining, via a communication interface, a set of time series data comprising a first segment of past time series data and a second segment of predicted time series data generated by a time-series prediction neural network model from the first segment of past time series data;
generating, by a first neural network based language model, a text description describing a forecast explanation based on a first input prompt combining the set of time series data;
generating, by a second neural network based language model, a third segment of past time series data based on the text description;
generating, by a third neural network based language model, a fourth segment of predicted time series data based on a second input prompt combining the third segment of past time series data and the text description of forecast explanation;
generating, by the time-series prediction neural network model, a fifth segment of predicted time series data from the third segment of past time series data;
determining a performance metric based on a comparison between the fourth segment of predicted time series data and the fifth segment of predicted time series data; and
generating a control command based on the text description to cause an action with a control system when the performance metric is within a threshold range.

7. The method of claim 6, wherein the time-series prediction neural network model receives the first segment of past time series data in a form of natural language, and generates the second segment of predicted time series data in a form of natural language.

8. The method of claim 6, wherein the performance metric comprises a symmetric mean absolute percentage error (sMAPE).

9. The method of claim 6, wherein the first neural network based language model generates the text description based on at least one of trend, seasonality, statistics, or cycle inconsistencies.

10. The method of claim 6, wherein the control system comprises an autonomous driving system, and the first segment of past time series data comprises a set of positioning data, a set of traffic data, or a set of road condition data.

11. The method of claim 6, wherein the generating, by the second neural network based language model, of the third segment of past time series data based on the text description comprises:
generating, by the second neural network based language model, a programming function based on the text description; and
generating, by a programming interpreter, the third segment of past time series data from the programming function.

12. The method of claim 11, wherein the programming function includes a Python function, and the programming interpreter includes a Python interpreter.

13. The method of claim 6, wherein the second neural network based language model generates the third segment of past time series data based on a set of random seed numbers.

14. A system for time series forecast, the system comprising:
a memory that stores a first neural network based language model, and a second neural network based language model, and a plurality of processor executable instructions;
a communication interface that receives a set of time series data comprising a first segment of past time series data and a second segment of predicted time series data generated by a time-series prediction neural network model from the first segment of past time series data; and
one or more hardware processors that read and execute the plurality of processor-executable instructions from the memory to perform operations comprising:
generating, by the first neural network based language model, a text description describing a forecast explanation based on a first input prompt combining the set of time series data;
generating, by the second neural network based language model, a third segment of predicted time series data based on a second input prompt combining the first segment of past time series data and the text description of forecast explanation;
determining a performance metric based on a comparison between the second segment of predicted time series data and the third segment of predicted time series data; and
generating a control command based on the text description to cause an action with a control system when the performance metric is within a threshold range.

15. The system of claim 14, wherein the time-series prediction neural network model receives the first segment of past time series data in a form of natural language, and generates the second segment of predicted time series data in a form of natural language.

16. The system of claim 14, wherein the performance metric comprises a symmetric mean absolute percentage error (sMAPE).

17. The system of claim 14, wherein the first neural network based language model generates the text description based on at least one of trend, seasonality, statistics, or cycle inconsistencies.

18. The system of claim 14, wherein the control system comprises an autonomous driving system, and the first segment of past time series data comprises a set of positioning data, a set of traffic data, or a set of road condition data.

19. A non-transitory machine-readable medium comprising a plurality of machine-executable instructions which, when executed by one or more processors, are adapted to cause the one or more processors to perform operations comprising:
obtaining, via a communication interface, a set of time series data comprising a first segment of past time series data and a second segment of predicted time series data generated by a time-series prediction neural network model from the first segment of past time series data;
generating, by a first neural network based language model, a text description describing a forecast explanation based on a first input prompt combining the set of time series data;
generating, by a second neural network based language model, a third segment of predicted time series data based on a second input prompt combining the first segment of past time series data and the text description of forecast explanation;
determining a performance metric based on a comparison between the second segment of predicted time series data and the third segment of predicted time series data; and
generating a control command based on the text description to cause an action with a control system when the performance metric is within a threshold range.

20. The non-transitory machine-readable medium of claim 19, wherein the time-series prediction neural network model receives the first segment of past time series data in a form of natural language, and generates the second segment of predicted time series data in a form of natural language.
